(19) United States
(12) Patent Application Publication
(10) Pub. No.: US 2004/0207754 A1
(43) Pub. Date: Oct. 21, 2004

(54) De-interlacing device of digital television set

(76) Inventors: Byung Tae Choi, Anyang-si (KR); Dong Il Han, Seoul (KR)

Correspondence Address: BIRCH STEWART KOLASCH & BIRCH, PO BOX 747, FALLS CHURCH, VA, 22040-0747, US

(21) Appl. No.: 10/751,998

(22) Filed: Jan. 7, 2004

(30) Foreign Application Priority Data
Jan. 8, 2003 (KR) P2003-1034

(51) Int. Cl. H04N 11/20; H04N 7/01

(52) U.S. Cl. 348/452

(57) ABSTRACT

Disclosed is a de-interlacing device of a digital television set, the de-interlacing device including: a field data provider for sequentially providing data of a plurality of consecutive fields; a pixel moving detector for receiving data of the consecutive fields from the field data provider to detect respective inter-field and inter-frame motion information; an intra-mode spatial interpolator for receiving data of the current field from the field data provider to output intra-mode interpolated pixel; an inter-mode temporal interpolator for outputting inter-mode interpolated pixel on basis of the respective inter-field and inter-frame motion information and the pixels having the same locations as the interpolated pixels at the fields before and after the field that is intended to be interpolated; and a soft switch for mixing the intra-mode interpolated pixel with the inter-mode interpolated pixel by using the respective inter-field and inter-frame motion information.

This application claims the benefit of the Korean Application No. P2003-1034 filed on Jan. 8, 2003, which is hereby incorporated by reference.

### BACKGROUND OF THE INVENTION

1. Field of the Invention

The present invention relates to a digital television set, and more particularly, to a de-interlacing device of a digital television set.

2. Discussion of the Related Art

Generally, a television image signal employs an interlaced scanning format of forming one frame by two fields. However, since a personal computer (PC) or a high-definition television (TV) set recently display in a general progressive scanning format, the conventional interlaced scanning format should be converted into the progressive scanning format in order to display the image signal of the interlaced scanning format through the PC or the high-definition television set in. This conversion is called “de-interlacing”.

A conventional de-interlacing technology is disclosed in U.S. Pat. Nos. 4,876,596, 5,550,592, 5,563,651, 5,596,371 and 5,689,301, and the above patents respectively disclose interpolating methods mainly summarized into three parts as below.

Firstly, disclosed is an interpolating method in which line information of the current field itself is repetitively used without considering motion between fields. Since this method does not require a field memory for finding motion in an image, it can be most simply embodied. However, the method has a drawback in that in case that there no exists a motion in the image, a better visual quality cannot be expected.

Secondly, disclosed is a method for finding and interpolating a motion vector representing a motion amount and direction between a field and a frame. The method can obtain a better visual quality in case that the motion vector is exactly found at a motion part, but requires an additional judgment logic for judging whether or not the obtained motion vector is exact. Further, the method has a drawback in that too many hardware sources are required to find the motion vector.

Thirdly, disclosed is a method in which only the motion amount between the field and the frame is simply extracted such that in case that there is the motion, the first method is used, and in case that there is not the motion, data of the same location at a before field is used as it is. This is described in more detail with reference to the attached drawings.

FIG. 1 is a view illustrating a construction diagram of a conventional de-interlacing device.

As shown in FIG. 1, the de-interlacing device includes a field data provider 10 for sequentially providing data of a plurality of consecutive fields; a moving detector 20 for receiving data of consecutive fields n+2, n+1, n, n−1 and n−2 from the field data provider 10 to detect respective inter-field and inter-frame motion information; an intra-mode spatial interpolator 30 for receiving data of the current field n from the field data provider 10 to output the intra-mode interpolated pixel; an inter-mode temporal interpolator 40 for receiving data of the fields n+1 and n−1 before and after the current field n from the field data provider 10 to output the inter-mode interpolated pixel on the basis of a pixel having the same location as the interpolated pixel at the before and after fields; and a soft switch 50 for mixing the intra-mode interpolated pixel with the inter-mode interpolated pixel by using respective inter-field and inter-frame motion information.

FIG. 2 is a view for depicting the conventional de-interlacing device of FIG. 1.

FIG. 2 illustrates the fields n−2, n−1, n, n+1, n+2 before and after the current field n having a pixel X that is intended to be interpolated, pixels A, B, C, D, E, F, G and H used for de-interlacing, and the motion information M1, M2, M3 and M4 used for inter-field interpolation.

An operation of the above-constructed de-interlacing device is described.

The field data provider 10 sequentially provides the plurality of the consecutive fields n−2, n−1, n, n+1, n+2, and the pixels A, B, C, D, E, F, G and H of respective fields. At this time, assuming that the location X is the pixel that is intended to be currently interpolated, the moving detector 20 judges the respective inter-field and inter-frame motion information at the location X.

Together with this, the intra-mode spatial interpolator 30 receives data of the current field n from the field data provider 10 to output the intra-mode interpolated pixel to the soft switch 50, and the inter-mode temporal interpolator 40 receives data of the fields n+1 and n−1 before and after the current field n from the field data provider 10 to output the inter-mode interpolated pixel to the soft switch 50 on the basis of the pixel having the same location as the before and after field data.

In case that there are not respective inter-field and inter-frame motion as a judgment result of the moving detector 20, the soft switch 50 outputs a resultant value of intra-mode interpolating at the field n. Further, in case that there are respective inter-field and inter-frame motion, the soft switch 50 obtains and outputs a simple mean value (A+B)/2 for data A and B of the before and after fields n−1 and n+1 which are identical with the location X.

In other words, in case that there are not respective inter-field and inter-frame motion, the third method can obtain a much better visual quality than the first method and can obtain a similar visual quality even with a much simpler circuit construction in comparison to the second method.

However, the third method has a drawback in that if it is judged that there is not the motion, since the pixel having the same location at the before field is used as it is, or the pixel value at the before and after fields is simply averaged and used, a better visual quality cannot be obtained if there is non-continuous motion.

On the other hand, Korean Pat. Publication No. 2002-064440 for compensating inter-field horizontal motion also discloses a mean value of two pixels set by a horizontal-direction motion vector so as to create the inter-mode interpolated pixel.

That is, in case that there is the motion between the field n and the field n−1 represented by M2, or in case that there is the motion between the field n and the field n+1 represented by M3, the conventional moving detector judges that there is the motion and then performs the inter-mode interpolation using only data of the field n.

However, the above method has a drawback in that an interpolated image is deteriorated worse than a case in which temporal interpolation is performed using data of only non-motion field.

### SUMMARY OF THE INVENTION

Accordingly, the present invention is directed to a de-interlacing device of a digital television set that substantially obviates one or more problems due to limitations and disadvantages of the related art.

An object of the present invention is to provide a de-interlacing device of a digital television set in which respective inter-field or inter-frame motion are exactly detected to create an exactly interpolated image.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a de-interlacing device of a digital television set, the de-interlacing device including: a field data provider for sequentially providing data of a plurality of consecutive fields; a pixel moving detector for receiving data of the consecutive fields from the field data provider to detect respective inter-field and inter-frame motion information; an intra-mode spatial interpolator for receiving data of the current field from the field data provider to output intra-mode interpolated pixel; an inter-mode temporal interpolator for outputting inter-mode interpolated pixel on the basis of the respective inter-field and inter-frame motion information and the pixels having the same locations as the interpolated pixels at the fields before and after the field that is intended to be interpolated; and a soft switch for mixing the intra-mode interpolated pixel with the inter-mode interpolated pixel by using the respective inter-field and inter-frame motion information.

Herein, the inter-mode temporal interpolator includes: at least two moving detectors for detecting certain inter-frame motion information between the fields; a first selector for obtaining the motion information between the before fields with respect to the pixel that is intended to be interpolated within the current field; a second selector for obtaining the motion information between the after fields with respect to the pixel that is intended to be interpolated within the current field; and a weighted mean unit for obtaining the inter-mode interpolated pixel on the basis of the motion information of the first and second selectors.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a construction diagram of a conventional de-interlacing device;

FIG. 2 is a view for depicting a conventional de-interlacing device of FIG. 1;

FIG. 3 is a view illustrating a construction diagram of a de-interlacing device according to a preferred embodiment of the present invention; and

FIG. 4 is a view illustrating a construction diagram of an inter-mode temporal interpolator of FIG. 3.

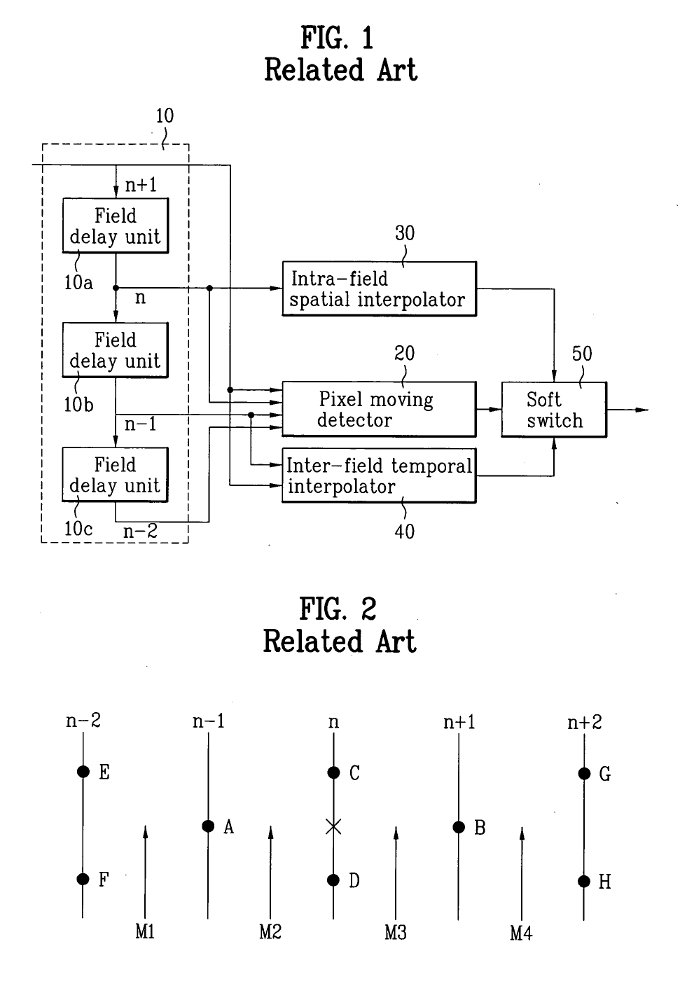

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

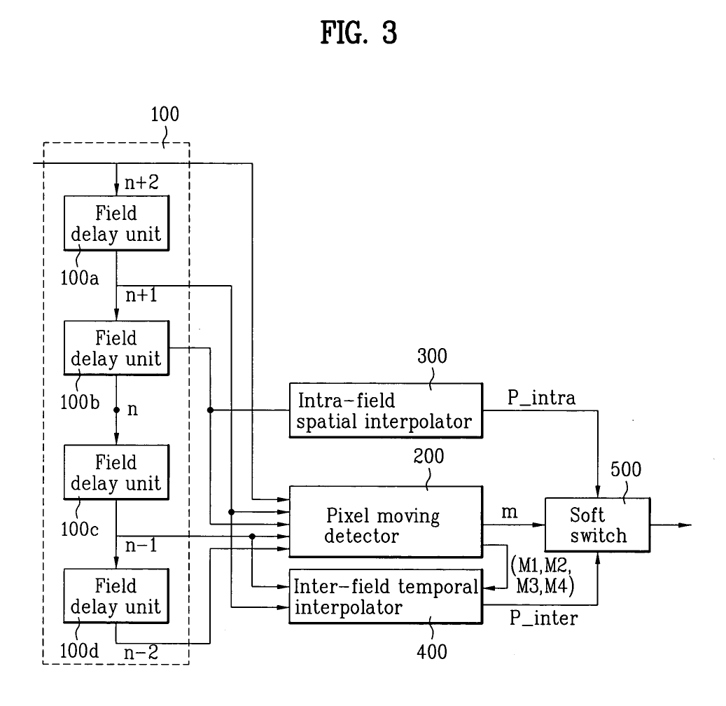

FIG. 3 is a view illustrating a construction diagram of a de-interlacing device according to a preferred embodiment of the present invention.

As shown in FIG. 3, the de-interlacing device includes a field data provider 100 for sequentially providing data of a plurality of consecutive fields; a pixel moving detector 200 for receiving data of consecutive fields n+2, n+1, n, n−1 and n−2 from the field data provider 100 to detect motion information m for soft-switching of an intra-mode interpolated pixel and an inter-mode interpolated pixel, and respective inter-field and inter-frame motion information M1, M2, M3 and M4 for inter-mode interpolating; an intra-mode spatial interpolator 300 for receiving data of the current field n from the field data provider 100 to output the intra-mode interpolated pixel; an inter-mode temporal interpolator 400 for outputting the inter-mode interpolated pixel on the basis of the motion information M1, M2, M3 and M4 and the pixel having the same location as the interpolated pixel at the fields (n−2, n−1) and the fields (n−1, n+2) before and after the field n that is intended to be interpolated; and a soft switch 500 for mixing the intra-mode interpolated pixel with the inter-mode interpolated pixel by using respective inter-field and inter-frame motion information.

An operation of the above constructed de-interlacing device will be described according to a preferred embodiment of the present invention.

First, the field data provider 100 uses a plurality of field delay units 100a to 100d to sequentially provide adjacent four pieces of field data. That is, the plurality of field delay units 100a to 100d of the field data provider 100 are serial-connected to sequentially store image signals of the remaining two before fields n−1 and n−2 and two after fields n+1 and n+2 excepting for the one reference (current) field n.

The pixel moving detector 200 receives the consecutive field data from the field data provider 100 to detect and output the inter-field and inter-frame motion information.

Further, the intra-mode spatial interpolator 300 receives the consecutive data from the field data provider 100 to create the intra-mode interpolated pixel.

Additionally, the inter-mode temporal interpolator 400 creates the inter-mode interpolated pixel by using the fields provided from the field data provider 100 on the basis of the motion information outputted from the pixel moving detector 200 and the pixels (pixels C and D shown in FIG. 2) having the same locations as the interpolated pixels at the fields before and after the field that is intended to be interpolated.

Lastly, the soft switch 500 creates a final interpolated pixel from the intra-mode interpolated pixel outputted from the intra-mode spatial interpolator 300 and the inter-mode interpolated pixel outputted from the inter-mode temporal interpolator 400.

At this time, it is desirable that the motion information outputted from the pixel moving detector 200 is comprised of the motion information m for soft-switching of the inter-mode interpolated pixel and the intra-mode interpolated pixel, and the motion information M1, M2, M3 and M4 for inter-mode interpolating.

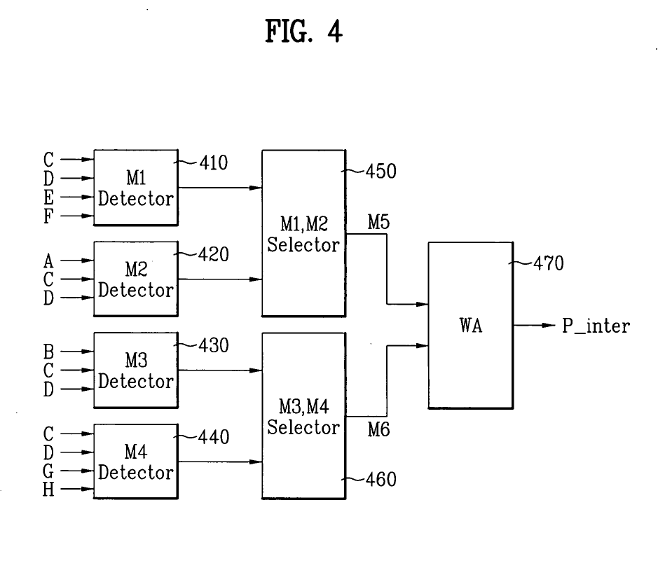

On the other hand, the intra-mode spatial interpolator 300 can function in a conventional method, and a part for inter-mode interpolating after receiving the motion information M1, M2, M3 and M4 from the pixel moving detector 200 is shown in FIG. 4.

FIG. 4 is a view illustrating a construction diagram of the inter-mode temporal interpolator of the inventive de-interlacing device where the motion information M1, M2, M3 and M4 are obtained and used to obtain the inter-mode interpolated pixel P_inter by using a weighted mean based on the motion information.

On the other hand, as shown in FIG. 4, the inter-mode temporal interpolator 400 includes M1, M2, M3, M4 detectors 410, 420, 430 and 440 for detecting certain inter-frame motion information between the fields; a first selector 450 for obtaining the motion information between the before fields n−1 and n−2 with respect to the pixel X that is intended to be interpolated within the current field n; a second selector 460 for obtaining the motion information between the after fields n+1 and n+2 with respect to the pixel X that is intended to be interpolated within the current field n; a weighted mean unit 470 for obtaining the inter-mode interpolated pixel P_inter on the basis of the motion information of the first and second selectors 450 and 460.

Herein, the motion information M1 detected in the M1 detector 410 represents the motion information between the fields n−2 and n, the motion information M2 detected in the M2 detector 420 represents the motion information between the fields n−1 and n, the motion information M3 detected in the M3 detector 430 represents the motion information between the fields n and n+1, and the motion information M4 detected in the M4 detector 440 represents the motion information between the fields n and n+2.

At this time, a value representing each of motion information is calculated by the following Equation (1).

M1=maximum (|C−E|,|D−F|)

M2=|A−(C+D)/2|

M3=|B−(C+D)/2|

M4=maximum (|C−G|,|D−H|) (1)

In the Equation (1), the pixels A, B, C, D, E, F, G and H can also really use a result of low pass filtering for horizontal-directional peripheral pixels so as to obtain a secure result against a noise in a real image.

Additionally, the first selector 450 outputs motion information M5 between the before fields n−1 and n−2 with respect to the pixel X that is intended to be interpolated within the current field n, and the second selector 460 outputs motion information M6 between the after fields n+1 and n+2 with respect to the pixel that is intended to be interpolated within the current field n.

At this time, the first and second selectors 450 and 460 are operated by the following Equation (2).

M5=maximum (M1, M2) or (M1+M2)/2

M6=maximum (M3, M4) or (M3+M4)/2 (2)

At this time, in real application, the motion information M1 and M4 can be omitted in case that it is difficult to use all the motion information M1, M2, M3 and M4 in consideration of a capacity of a field memory and the like that the field data provider 100 requires. In this case, the motion information M5 equals to the motion information M2, and the motion information M6 equals to the motion information M3.

Additionally, the weighted mean unit 470 obtains the inter-mode interpolated pixel P_inter as in the following Equation (3) by using the motion information representing the motion between the fields of temporal before and after direction, that is, the motion information M5 representing the motion between the before fields n−1 and n−2 with reference to the field n and the motion information M6 representing the motion between the after fields n+1 and n+2.

P_inter=(M5×B+M6×A)/(M5+M6) (3)

Lastly, the soft switch 500 performs weighted-mean of the intra-mode interpolated pixel P_intra and the inter-mode interpolated pixel P_inter on the basis of the motion information m to create the final interpolated pixel by using the Equation (4).

Output value of the soft switch 500=((1−m)×P_inter+m×P_intra) (4)

As described above, the inventive de-interlacing device has effects as below.

First, the conventional method judges a moving pixel to perform the inter-mode interpolating even in case that there is the motion at only any one of the before field or the after field with reference to the pixel of the current field, whereas even in this case, the present invention has an effect in which a better visual quality can be obtained as a result of de-interlacing since the field is really judged in the direction of non-motion such that only data of the field is used.

Secondly, the present invention has an effect in which each of the moving detectors of FIG. 4 can be formed to have a simple circuit construction since it is structured similarly with the moving detector used for soft switching of the inter-mode/intra-mode interpolators.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A de-interlacing device of a digital television set, the de-interlacing device comprising:
a field data provider for sequentially providing data of a plurality of consecutive fields;
a pixel moving detector for receiving data of the consecutive fields from the field data provider to detect respective inter-field and inter-frame motion information;
an intra-mode spatial interpolator for receiving data of the current field from the field data provider to output intra-mode interpolated pixel;
an inter-mode temporal interpolator for outputting inter-mode interpolated pixel on basis of the respective inter-field and inter-frame motion information and the pixels having the same locations as the interpolated pixels at the fields before and after the field that is intended to be interpolated; and
a soft switch for mixing the intra-mode interpolated pixel with the inter-mode interpolated pixel by using the respective inter-field and inter-frame motion information.

2. The de-interlacing device of claim 1, wherein the field data provider comprises at least two field delay units serial-connected to sequentially store image signals of the before field and the after field excepting for one current field.

3. The de-interlacing device of claim 1, wherein the inter-mode temporal interpolator comprises:
at least two moving detectors for detecting certain inter-frame motion information between the fields;
a first selector for obtaining the motion information between the before fields with respect to the pixel that is intended to be interpolated within the current field;
a second selector for obtaining the motion information between the after fields with respect to the pixel that is intended to be interpolated within the current field; and
a weighted mean unit for obtaining the inter-mode interpolated pixel on the basis of the motion information of the first and second selectors.

4. A de-interlacing device of a digital television set, the de-interlacing device comprising:
a field data provider for sequentially providing data of a plurality of consecutive fields (n+2, n+1, n, n−1, n−2);
a pixel moving detector for receiving data of the consecutive fields n+2, n+1, n, n−1 and n−2 from the field data provider to detect motion information m for soft-switching, and respective inter-field and inter-frame motion information;
an intra-mode spatial interpolator for receiving data of the current field n from the field data provider to output an intra-mode interpolated pixel P_intra;
an inter-mode temporal interpolator for outputting an inter-mode interpolated pixel on the basis of the respective inter-field and inter-frame motion information m and the pixel having the same location as the interpolated pixel at the fields (n−2, n−1) and the fields (n+1, n+2) before and after the field n that is intended to be interpolated; and
a soft switch for mixing the intra-mode interpolated pixel P_intra with the inter-mode interpolated pixel P_inter by using the inter-field and inter-frame motion information m.

5. The de-interlacing device of claim 4, wherein the field data provider comprises at least two field delay units serial-connected to sequentially store image signals of the before fields n−1 and n−2 and the after fields n+1 and n+2 excepting for the current field n.

6. The de-interlacing device of claim 4, wherein the inter-mode temporal interpolator comprises:
at least two moving detectors M1, M2, M3 and M4 for detecting certain inter-frame motion information between the fields;
a first selector for obtaining the motion information between the before fields n−1 and n−2 with respect to the pixel X that is intended to be interpolated within the current field n;
a second selector for obtaining the motion information between the after fields n+1 and n+2 with respect to the pixel X that is intended to be interpolated within the current field n; and
a weighted mean unit for obtaining the inter-mode interpolated pixel P_inter on the basis of the motion information M5 and M6 of the first and second selectors.

7. The de-interlacing device of claim 6, wherein the at least two detectors respectively detect the inter-frame motion information M1 between the fields n−2 and n, the inter-field motion information M2 between the fields n−1 and n, the inter-field motion information M3 between the fields n and n+1, and t inter-frame motion information M4 between the fields n and n+2.

8. The de-interlacing device of claim 7, wherein the motion information M1, M2, M3 and M4 are calculated by the following Equation.
M1=maximum (|C−E|,|D−F|)
M2=|A−(C+D)/2|

M3=|B−(C+D)/2|

M4=maximum (|C−G|,|D−H|).
Herein, the pixel A represents a pixel value located at the field n−1, the pixel B represents a pixel value located at the field n+1, the pixels C and D represent pixel values located at the field n, the pixels E and F represent pixel values located at the field n−2, and the pixels G and H represent pixel values located at the field n+2.

9. The de-interlacing device of claim 7, wherein the motion information M1, M2, M3 and M4 are obtained by low pass filtering for horizontal-directional peripheral pixels of the pixels A, B, C, D, E, F, G and H.
Herein, the pixel A represents a pixel value located at the field n−1, the pixel B represents a pixel value located at the field n+1, the pixels C and D represent pixel values located at the field n, the pixels E and F represent pixel values located at the field n−2, and the pixels G and H represent pixel values located at the field n+2.

10. The de-interlacing device of claim 6, wherein the motion information M5 and M6 are respectively obtained by the following Equation.
M5=maximum (M1, M2) or (M1+M2)/2
M6=maximum (M3, M4) or (M3+M4)/2

11. The de-interlacing device of claim 6, wherein the weighted mean unit obtains the inter-mode interpolated pixel P_inter by the following Equation.
P_inter=(M5×B+M6×A)/(M5+M6)
Herein, the pixel A represents the pixel value located at the field n−1, and the pixel B is the pixel value located at the field n+1.

12. The de-interlacing device of claim 4, wherein the soft switch obtains a final interpolated pixel by the following Equation.
Output value of the soft switch 500=((1−m)×P_inter+m×P_intra)
